(19) United States
(12) Patent Application Publication
(10) Pub. No.: US 2021/0171810 A1
(43) Pub. Date: Jun. 10, 2021

(54) Two Step Adhesive System

(71) Applicant: Henkel IP & Holding GmbH, Dusseldorf (DE)

(72) Inventors: Nigel Sweeney, Dublin (IE); Darren Nolan, Dublin (IE); Brendan Kneafsey, Dublin (IE); Mark Loane, Dublin (IE); James Houlihan, Dublin (IE); Michael Doherty, Dublin (IE)

(21) Appl. No.: 17/163,976

(22) Filed: Feb. 1, 2021

Related U.S. Application Data
(63) Continuation of application No. PCT/EP2019/071981, filed on Aug. 15, 2019.

(30) Foreign Application Priority Data
Aug. 16, 2018 (GB) 1813404.9

(51) Int. Cl. C09J 11/06; C08K 5/405; C08K 5/05

(52) U.S. Cl. CPC C09J 11/06; C08K 5/405; C08K 5/05; C09J 2453/003; C09J 2425/003; C09J 2409/003; C09J 2477/006; C09J 2433/003

(57) ABSTRACT

Benzoylthiourea or benzoylthiourethane derivatives in organohalides as carriers for primers for two step adhesive systems are provided.

### BACKGROUND

### Field

Cure accelerators, such as benzoylthiourea or benzoylthiourethane derivatives, in organohalides as carriers in primers for two step adhesive systems are provided.

### Brief Description Of Related Technology

Curable adhesive and sealant compositions oftentimes rely on curatives to make them commercially attractive options for end users. Curable adhesive and sealant compositions come in one part formats, two part formats and two step formats depending on the performance profile they are designed to meet and the constituents used to prepare the compositions. Anaerobic adhesives are prominent one part compositions and generally are well-known. See e.g., R. D. Rich, “Anaerobic Adhesives” in Handbook of Adhesive Technology, 29, 467-79, A. Pizzi and K. L. Mittal, eds., Marcel Dekker, Inc., New York (1994), and references cited therein. Their uses are legion and new applications continue to be developed.

Conventional anaerobic adhesives ordinarily include a free-radically polymerizable acrylate ester monomer, together with a peroxy initiator and an inhibitor component. Oftentimes, such anaerobic adhesive compositions also contain accelerator components to increase the speed with which the composition cures.

Anaerobic cure-inducing compositions ordinarily used in commercial anaerobic adhesive and sealant compositions to induce and accelerate cure ordinarily include saccharin, toluidines, such as N,N-diethyl-p-toluidine (“DE-p-T”) and N,N-dimethyl-o-toluidine (“DM-o-T”), acetyl phenylhydrazine (“APH”), maleic acid, and quinones, such as napthaquinone and anthraquinone. See e.g. U.S. Pat. No. 3,218,305 (Krieble), U.S. Pat. No. 4,180,640 (Melody), U.S. Pat. No. 4,287,330 (Rich) and U.S. Pat. No. 4,321,349 (Rich).

GC Corporation submitted to the U.S. Patent and Trademark Office a patent application, which published as U.S. Patent Application Publication No. 2010/0249266, and is directed to a polymerizable composition comprising a first paste and a second paste, where the first paste comprises a polymer of α,β, unsaturated monocarboxylic acid or α,β, unsaturated dicarboxylic acid, water, and a hydroperoxide as a peroxide, and where the second paste comprises a (meth)acrylate compound not having an acid group, fluoroaluminosilicate glass powder, a thiourea derivative as a reducing material, and a vanadium compound as a polymerization accelerator.

U.S. Pat. No. 9,371,473 is directed to a process of preparing a reaction product from a curable composition by applying a derivative of a benzoyl thiourea or benzoyl thiourethane of specified structures to a substrate surface, applying a composition comprising a (meth)acrylate component and an oxidant to that desired substrate surface, mating a second surface to that substrate to form an assembly and exposing the assembly to appropriate conditions for a time sufficient to cure the composition.

Notwithstanding the state of the technology, there is an on-going desire to find alternative technologies for accelerating the cure of curable compositions to differentiate existing products and provide supply assurances in the event of shortages or cessation of supply of raw materials. Accordingly, it would be desirable to identify new materials, which function as improved accelerators for curable compositions.

### SUMMARY

Primers for use in two step adhesive systems comprising organohalides as a carrier for derivatives of benzoylthiourea or benzoylthiourethane are provided.

For instance, the benzoylthiourea or benzoylthiourethane derivatives may be within general structure I

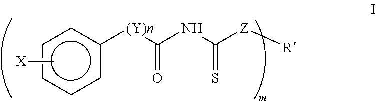

where Z is O or N—R, where R is selected from hydrogen, alkyl, alkenyl, hydroxyalkyl, hydroxyalkenyl, carbonyl, alkylene (meth)acrylate, carboxyl, or sulfonato, or R′ is a direct bond attaching to the phenyl ring; R′ is selected from hydrogen, alkyl, alkenyl, cycloalkyl, aryl, hydroxyalkyl, hydroxyalkenyl, alkylene- or alkenylene-ether, carbonyl, alkylene (meth)acrylate, carboxyl, nitroso or sulfonato; X is halogen, alkyl, alkenyl, hydroxyalkyl, hydroxyalkenyl, alkoxy, amino, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2.

The organohalides are used as a carrier for the benzoylthiourea or benzoylthiourethane derivatives in a primer to be applied to a substrate surface. Examples of the organohalides are given below.

The benzoylthiourea or benzoylthiourethane derivatives in combination with the organohalide carrier, act to accelerate cure of curable compositions and provide adhesive systems with good cure through volume.

The present invention will be more fully appreciated by a reading of the “Detailed Description”, and the illustrative examples which follow thereafter.

### BRIEF DESCRIPTION OF THE FIGURES

FIG. 1 depicts a plot of tensile shear strengths after 24 hours of room temperature cure of two step adhesive systems with an organohalide carrier and two step adhesive systems with a non-organohalide carrier.

FIG. 2 depicts a plot of tensile shear strengths after 20 minutes of curing at 65° C. and 24 hours of room temperature cure of two step adhesive systems with an organohalide carrier and two step adhesive systems with a non-organohalide carrier.

### DETAILED DESCRIPTION

The invention described herein provides a process for preparing a reaction product from a curable composition that comprises using a composition comprising a benzoylthiourea or benzoylthiourethane derivative in a organohalide carrier as a primer.

More particularly, the invention provides a process of preparing a reaction product from a curable composition, comprising the steps of:

applying a composition comprising an organohalide and a benzoylthiourea or benzoylthiourethane derivative within structures I or IA

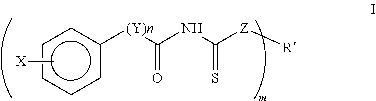

where R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2, or

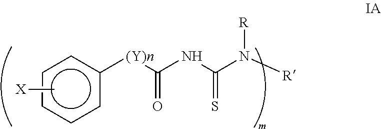

where R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and

—PO(NHCONHCSNH₂)NH—; and n is 0 or 1 and m is 1 or 2, to a surface of a polyamide substrate,

applying a composition comprising a (meth)acrylate component and an oxidant to the primer-applied polyamide surface or to a surface of a second substrate,

mating the two surfaces to form an assembly, and

exposing the assembly to appropriate conditions for a time sufficient to cure the composition.

In another aspect, the invention provides a process for preparing a reaction product from a curable composition, comprising the steps of:
applying a composition comprising a (meth)acrylate component and an oxidant to a surface of a substrate,
applying to a surface of a polyamide substrate a composition comprising an organohalide and a benzoylthiourea or benzoylthiourethane derivative within structures I or IA

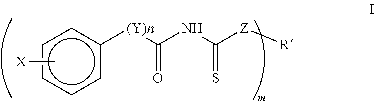

where R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2, or

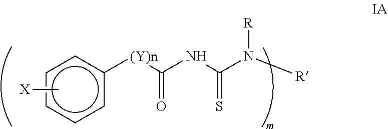

where R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2, to that surface,
mating the surfaces to form an assembly, and
exposing the assembly to appropriate conditions for a time sufficient to cure the composition.

In yet another aspect, the invention provides a process for preparing a reaction product from a curable composition, comprising the steps of:
applying a composition comprising a (meth)acrylate component, an organohalide, and a benzoylthiourea or benzoylthiourethane derivative within structures I or IA

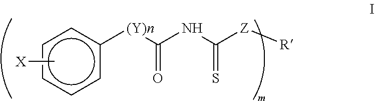

where R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2, or

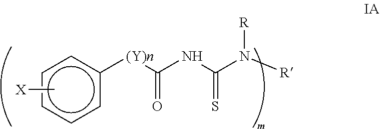

where R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2, to a surface of a polyamide substrate,
applying an oxidant to that surface,
mating a second surface to that surface to form an assembly, and
exposing the assembly to appropriate conditions for a time sufficient to cure the composition.

Here, a primer can use cure accelerators, such as benzoylthiourea or benzoylthiourethane derivatives, in an organohalide. Specifically, cure accelerators within structure I are useful

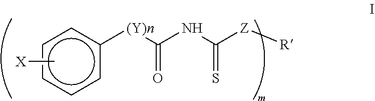

where Z is O or N—R, where R is selected from hydrogen, alkyl, alkenyl, aryl, hydroxyalkyl, hydroxyalkenyl, alkylene (meth)acrylate, carbonyl, carboxyl, or sulfonato, and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2.

As noted above, a more specific general structure is shown below:

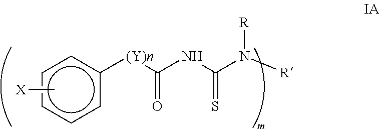

where R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2.

And even more specifically, the inventive cure accelerators include

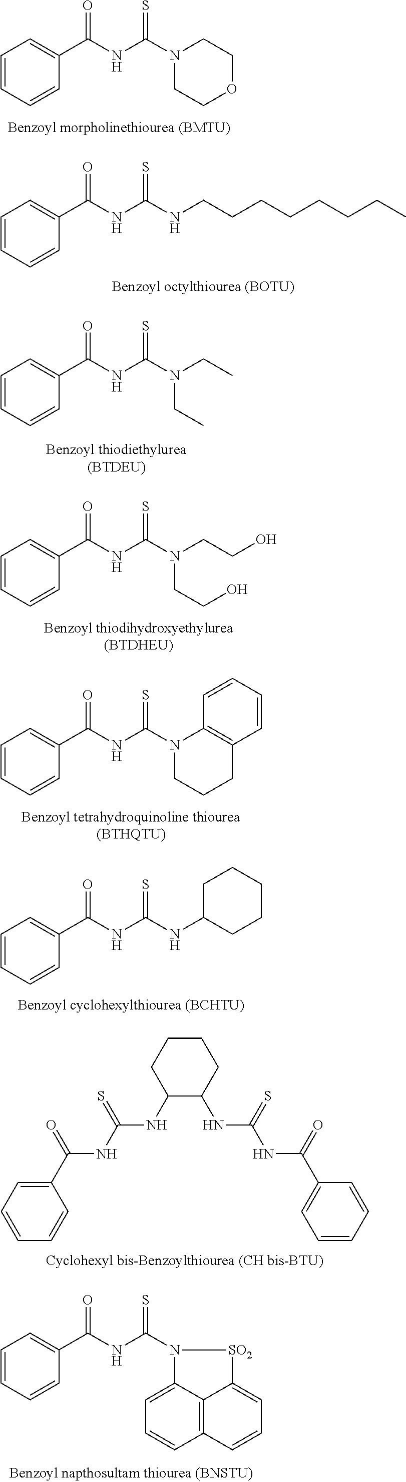

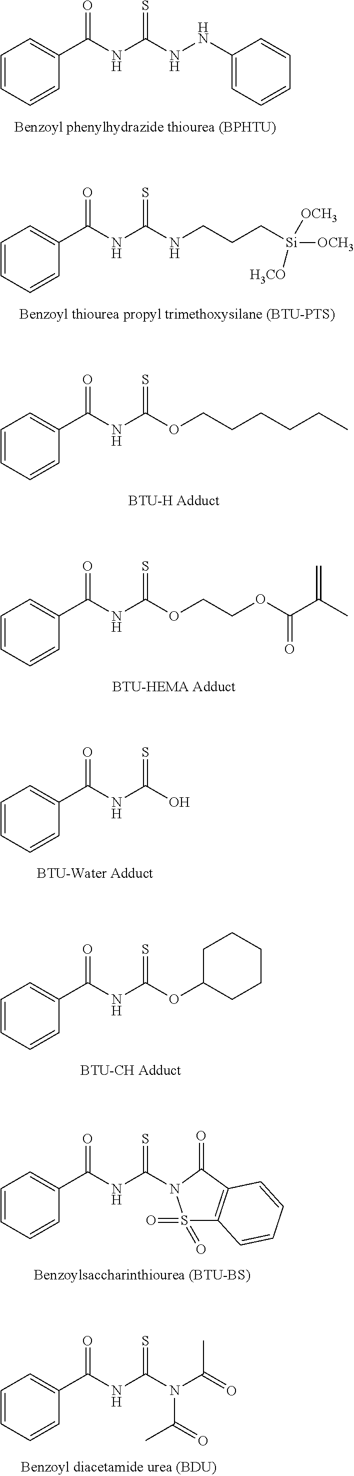

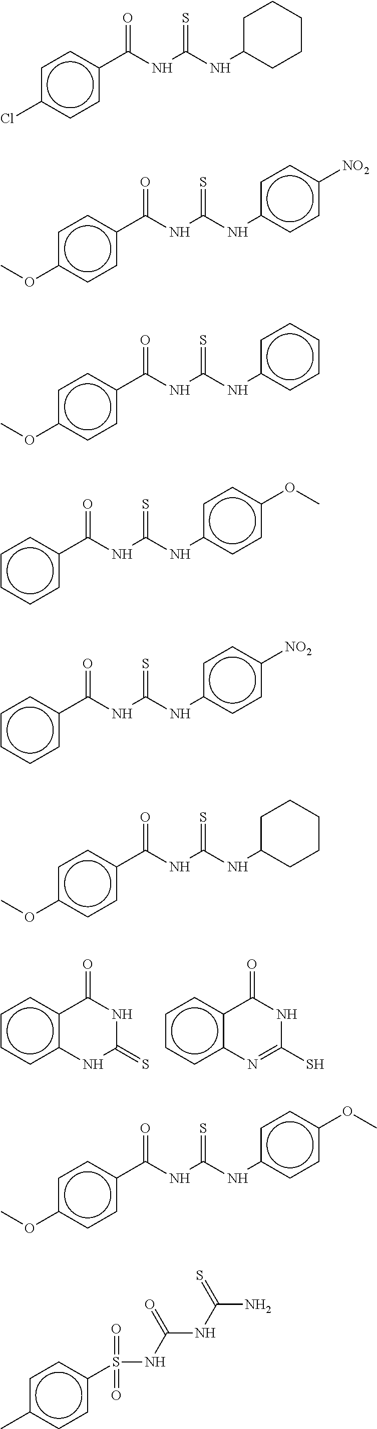

Benzoyl cyclohexylthiourea is particularly useful as a cure accelerator in a carrier to form a primer composition, the structure of which is shown below.

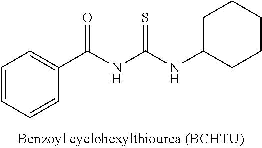 [SMILES: O=C(NC(=S)NC1CCCCC1)c1ccccc1]

The benzoylthiourea or benzoylthiourethane derivatives, such as those represented by Formula I and IA above, may be used as cure accelerators in amounts of about 0.1 to about 5 percent by weight, such as about 1 to about 2 percent by weight, based on the total weight of the primer composition.

The benzoylthiourea or benzoylthiourethane derivatives display enhanced solubility, stability, and activity in an organohalide carrier, as compared with other known carriers. And the organohalide carrier promotes adhesion to polyamides, as compared with other known carriers.

Organohalides useful as the carrier in the inventive composition that are liquid at room temperature and have a boiling point in the range of 20 to 120° C. such that the organohalide evaporates to leave a dry touch coating. Useful organohalides include halogenated alkyl alcohols, in which at least one of the hydrogen atoms is substituted by a halogen atom. In particular, useful alkyl alcohols include halogenated derivatives of ethyl alcohol, halogenated derivatives of propane, some of which having one or more hydroxyl groups, or halogenated derivatives of butane, some of which having one or more hydroxyl groups. Useful halogenated derivatives of ethyl alcohol include 2,2,2-trifluoroethanol, 2,2,2-trichloroethanol, 2,2,2-tribromoethanol, 2,2,2-trifluoroethanol, 2,2-dichloroethanol, 2-bromoethanol. Useful derivatives of propane include 2,2,3,3,3-pentafluoropropanol, 1,1,1,3,3,3-hexafluoro-2-propanol, 1,1,1,3,3,3-hexafluoro-2-methyl-2-propanol and 2,2,3,3-tetrafluro-1-propanol. Useful derivatives of butane include 2,2,3,3,4,4,4-heptafluro-1-butanol, 2,2,3,4,4,4-hexafluro-1-butanol and perfluoro-tert-butyl alcohol.

Other organohalides that are useful as carriers in the inventive composition include halogenated alkyl ethers. Useful halogenated alkyl ethers include bis(2,2,2-trifluoroethyl) ether, methylperfluoropropyl ether, methylperfluorobutane ether, methylperfluoroisobutyl ether, ethyloxynonaflurobutane, ethylnonfluoroisobutyl ether and 3-methoxyperfluro(2-methylpentane.

Other organohalides that are useful as carriers are alkylhalides. Useful alkylhalides include 1,2-trans-dichloroethylene, tetradecafluorohexane and 1,1,1,2,3,4,4,5,5,5-decafluoropentane.

The organohalide can be present in the primer composition in an amount of 50 to 99 percent by weight, based on the total weight of the primer composition, before the composition is cured. The organohalide of the primer will evaporate after application to the substrate surface. When the primer is placed on the substrate surface, before the composition comprising a (meth)acrylate component and/or an oxidant is applied to or on contacted or mated with the primer-applied surface, the organohalide will have evaporated before curing begins.

(Meth)acrylate monomers suitable for use as the (meth)acrylate component in the two step adhesive systems may be chosen from a wide variety of materials, such as these represented by H₂C═CGCO₂R¹, where G may be hydrogen or alkyl groups having from 1 to about 4 carbon atoms, and R¹ may be selected from alkyl, cycloalkyl, alkenyl, cycloalkenyl, alkaryl, aralkyl or aryl groups having from 1 to about 16 carbon atoms, any of which may be optionally substituted or interrupted as the case may be with silane, silicon, oxygen, halogen, carbonyl, hydroxyl, ester, carboxylic acid, urea, urethane, carbonate, amine, amide, sulfur, sulfonate, sulfone and the like.

Additional (meth)acrylate monomers suitable for use herein include polyfunctional (meth)acrylate monomers, such as, but not limited to, di- or tri-functional (meth)acrylates like polyethylene glycol di(meth)acrylates, tetrahydrofuran (meth)acrylates and di(meth)acrylates, hydroxypropyl (meth)acrylate (“HPMA”), hexanediol di(meth)acrylate, trimethylol propane tri(meth)acrylate (“TMPTMA”), diethylene glycol dimethacrylate, triethylene glycol dimethacrylate (“TRIEGMA”), tetraethylene glycol dimethacrylate, dipropylene glycol dimethacrylate, di-(pentamethylene glycol) dimethacrylate, tetraethylene diglycol diacrylate, diglycerol tetramethacrylate, tetramethylene dimethacrylate, ethylene dimethacrylate, neopentyl glycol diacrylate, trimethylol propane triacrylate and bisphenol-A mono and di(meth)acrylates, such as ethoxylated bisphenol-A (meth)acrylate (“EBIPMA”), and bisphenol-F mono and di(meth)acrylates, such as ethoxylated bisphenol-F (meth) acrylate.

Still other (meth)acrylate monomers that may be used herein include silicone (meth)acrylate moieties (“SiMA”), such as those taught by and claimed in U.S. Pat. No. 5,605,999 (Chu), the disclosure of which is hereby expressly incorporated herein by reference.

Of course, combinations of these (meth)acrylate monomers may also be used.

The (meth)acrylate component should comprise from about 10 percent by weight to about 90 percent by weight, such as about 60 percent by weight to about 90 percent by weight, based on the total weight of the adhesive system.

Additional components may be included in traditional curable compositions to alter the physical properties of either the curable compositions or the reaction products thereof.

For instance, one or more of maleimide components, thermal resistance-conferring coreactants, diluent components reactive at elevated temperature conditions, mono- or poly-hydroxyalkanes, polymeric plasticizers, and chelators (see U.S. Pat. No. 6,043,327, the disclosure of which is hereby expressly incorporated herein by reference) may be included to modify the physical property and/or cure profile of the formulation and/or the strength or temperature resistance of the cured adhesive.

When used, the maleimide, coreactant, reactive diluent, plasticizer, and/or mono- or poly-hydroxyalkanes, may be present in an amount within the range of about 1 percent by weight to about 30 percent by weight, based on the total weight of the composition.

The curable compositions may also include other conventional components, such as free radical initiators, other free radical co-accelerators, inhibitors of free radical generation, as well as metal catalysts, such as iron and copper. Depending on the cure environment some or all of these components might ordinarily be used, particularly if cure is to occur under anaerobic conditions.

A number of well-known initiators of free radical polymerization (or, oxidants) are typically incorporated into the curable compositions including, without limitation, hydroperoxides, such as cumene hydroperoxide (“CHP”), para-menthane hydroperoxide, t-amyl hydroperoxide, 1,1,3,3-tetramethylbutyl hydroperoxide and t-butyl hydroperoxide (“TBH”). Other peroxides include t-butyl perbenzoate, benzoyl peroxide, dibenzoyl peroxide, 1,3-bis(t-butylperoxyisopropyl)benzene, diacetyl peroxide, butyl 4,4-bis(t-butylperoxy)valerate, p-chlorobenzoyl peroxide, cumene hydroperoxide, t-butyl cumyl peroxide, t-butyl perbenzoate, di-t-butyl peroxide, dicumyl peroxide, 2,5-dimethyl-2,5-di-t-butylperoxyhexane, 2,5-dimethyl-2,5-di-t-butyl-peroxyhex-3-yne, 4-methyl-2,2-di-t-butylperoxypentane and combinations thereof.

It may be desirable in some instances to provide the oxidant in an encapsulated form.

Such oxidants are typically employed in the range of from about 0.1 percent by weight to about 10 percent by weight, based on the total weight of the composition, with about 1 to about 5 percent by weight being desirable.

Stabilizers and inhibitors (such as phenols including hydroquinone and quinones) may also be employed to control and prevent premature oxidant decomposition and polymerization of the curable compositions.

In the context of anaerobic curable compositions, chelating agents [such as the tetrasodium salt of ethylenediamine tetraacetic acid (“EDTA”)] to trap trace amounts of metal contaminants therefrom, may also be used. When used, chelators may ordinarily be present in the compositions in an amount from about 0.001 percent by weight to about 0.1 percent by weight, based on the total weight of the composition.

Other agents such as thickeners, non-reactive plasticizers, fillers, toughening components (such as elastomers and rubbers), and other well-known additives may be incorporated therein where the art-skilled believes it would be desirable to do so.

The adhesive system may be prepared using conventional methods which are well known to those persons of skill in the art. For instance, the components of the curable composition may be mixed together in any convenient order consistent with the roles and functions the components are to perform in the compositions. Conventional mixing techniques using known apparatus may be employed.

The two step adhesive system may be used to bond a variety of substrates to perform with the desired benefits and advantages described herein. However, at least one of the substrates to be bonded is one constructed from a polyamide. For instance, appropriate polyamide substrates include glass-fiber reinforced polyamide substrate. The glass-fiber reinforced polyamide substrate may contain 50% filler by weight. For example, the polyamide substrate can be Kalix® 9950 high performance polyamide from Solvay Specialty Polymers.

In the context of two-step adhesive systems, here, instead of the conventional approaches, a primer of the so-described benzoylthiourea or benzoylthiourethane derivatives and organohalides may be used to facilitate cure of the adhesive composition through the bond line. The primer is applied as a solution of the benzoylthiourea or benzoylthiourethane derivative in an organohalide carrier.

In view of the above description, it is clear that a wide range of practical opportunities is provided. The following examples are provided for illustrative purposes only, and are not to be construed so as to limit in any way the teaching herein.

### Examples

Many of the so-described benzoylthiourea or benzoylthiourethane derivatives were synthesized as set forth below.

### A. Synthesis

### Benzoyl Cyclohexylthiourea (“BCHTU”) Adduct

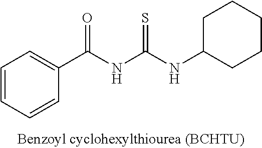 [SMILES: O=C(NC(=S)NC1CCCCC1)c1ccccc1]

To a 250 mL 3-neck RBF equipped with a condenser, magnetic stirrer, thermo-probe, nitrogen purge and pressure-equilibrated addition funnel was added benzoyl isothiocyanate (25.0 g, 0.150 mol) followed by dichloromethane (100 mL). The mixture was cooled in an ice-water bath at a temperature below 5° C., at which point cyclohexylamine (15.0 g, 0.150 mol) and dichloromethane (100 mL) were added slowly over a period of time of about 30 minutes. The ice-water bath was removed and the reaction mixture was stirred under a nitrogen purge overnight. The reaction mixture was then concentrated in vacuo at a temperature of 40° C. to provide an orange-yellow solid. The solid was dried to constant weight in vacuo at a temperature of 50° C. and a pressure of <1 mTorr in a 99% yield. The solid was determined to have a melting point of 67.8° C.

### B. Use of Thiourea in Organohalide Carrier as a Primer in Two-Step Adhesive System Adhesive

A 50 g batch of the adhesive, Formulation 1 shown in Table 1, below was made as follows. Firstly, Styrene-Butadiene-Styrene (SBS) block co-polymer rubber pellets were soaked for a period of time of about 2 hours in methyl methacrylate. The methyl methacrylate-soaked SBS Rubber was mixed in a speedmixer DAC 150.1 FVZ (from Hauschild &Co. KG, Hamm, Germany) at 2500 rpm for 3 minutes. To the pre-dissolved SBS Core Shell Rubber in methyl methacrylate the remainder of the ingredients listed in Table 1 were added by mixing in the speedmixer at 2500 rpm for two 3 minute periods to form a uniform dispersion.

TABLE 1

| Ingredient | Amount (Wt %) |
|---|---|
| Methyl Methacrylate- | 67.4 |
| SBS Rubber Premix ^{[1]} | |
| SBM Core Shell | 4.5 |
| Rubber ^{[2]} | |
| Methacrylic Acid | 9 |
| Liquid Polybutadiene | 13 |
| Rubber ^{[3]} | |
| Cumene Hydroperoxide | 5 |
| Silica ^{[4]} | 0.7 |
| Paraffin Wax ^{[5]} | 0.4 |

^{[1]} Premix is 60% Methyl Methacrylate and 40% Kraton D1155ES.
^{[2]} Clearstrength XT100
^{[3]} Hypro VTB 2000x168
^{[4]} Cabosil TS720
^{[5]} IGI 1260

### Primer

Two primers, A and B, were made by dissolving BCHTU in carriers at room temperature with stirring for about 15 minutes. A third primer, C, was prepared in the same manner as Primers A and B without the addition of BCHTU. Primers A and C are used for comparative purposes. The formulations of Primers A, B and C are shown below in Table 2.

TABLE 2

| | Primer/Amt (Wt %) | | |
|---|---|---|---|
| Ingredient | A | B | C |
| Novec Engineered Fluid 7100^{[6]} | — | 75 | 80 |
| 2,2,3,3-Tetrafluoro-1-propanol | — | 20 | 20 |
| Isopropanol | 95 | — | — |
| BCHTU | 5 | 5 | — |

^{[6]} Supplied by 3M, comprises a mixture of methylperfluorobutane ether and methylperfluoroisobutyl ether.

### Adhesion Testing

Adhesion tests were done according to the ISO test method 4587 “Adhesives—Determination of Tensile Lap-Shear Strength of High Strength Adhesive Bonds”. Test coupons made from Kalix® 9950, Nylon 6,6 and stainless steel (SUS 304 grade, degreased before use) were prepared for assembly by applying each primer to the area to be bonded (12.7 mm×12.7 mm) by brush application. The carrier in the primer (Primers A and B) evaporated from the coupon surface in a fume hood with flow velocity of 0.5 m/s within 5 minutes leaving BCHTU on the surface of the coupon to be bonded. Sufficient adhesive (Formulation 1) was applied to cover the bond area using a wooden spatula. The coupons with their respective primer and Formulation 1 were then assembled and clamped with Hargrave No. 1 clamps. The adhesive between the assembled coupons was allowed to cure for 24 hours at room temperature or for 20 minutes at a temperature of 65° C. followed by 24 hours at room temperature.

The loads at failure were determined by using a Zwick Z010 Testing Machine equipped with a 10 kN load cell. Bonded assemblies were pulled at a cross head speed of 2 mm/min.

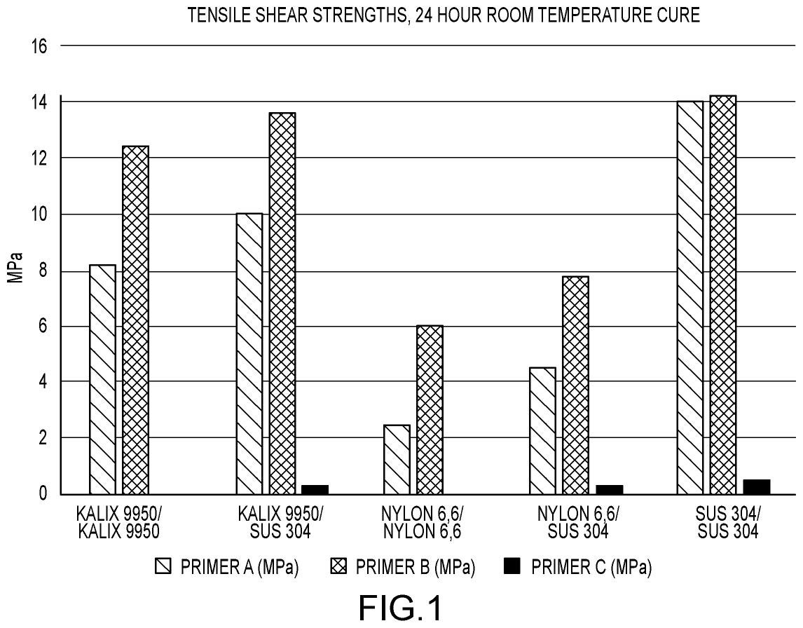

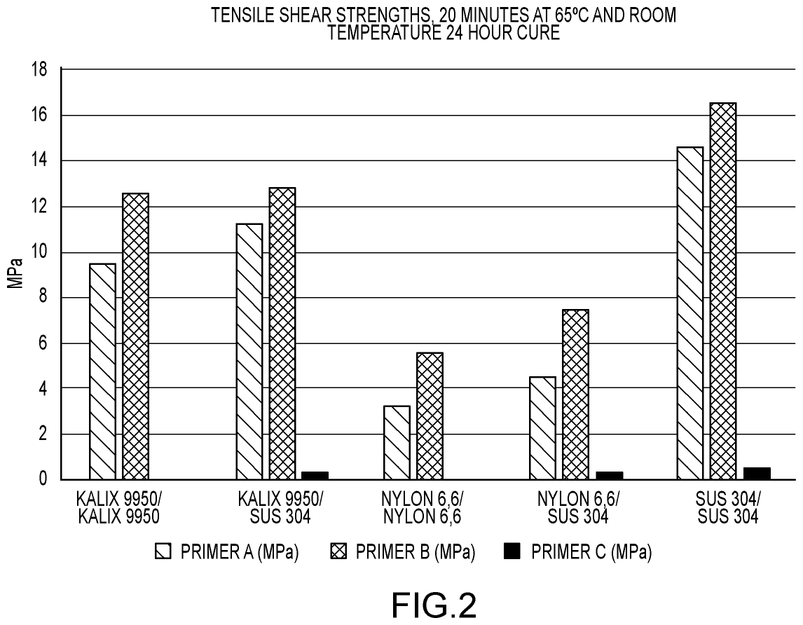

Adhesion tests were performed on the bonded substrates [made from Kalix® 9950, Nylon 6,6 and stainless steel (SUS 304 grade, degreased before use)] using Formulation 1 and Primers A, B and C as indicated above. The shear strength results for room temperature, 24-hour cure, and 20 minutes of cure at 65° C., followed by 24-hour room temperature cure are shown in FIGS. 1 and 2, respectively. The data from these figures is reproduced in Table 3 and Table 4, respectively.

As demonstrated by these results, Primer B shows significant improvements for adhesion to polyamides over Primer A, when the carrier is changed from an alkanol to a carrier containing halogenated alkanols and ethers. Primer C, on the other hand, which comprises only organohalide but no BCHTU shows very poor adhesion to polyamides.

Specifically, when looking at the figures, one sees pronounced improvements using Primer B of the present invention, as compared with comparative Primer A which does not contain 2,2,3,3-tetrafluoro-1-propanol, and comparative Primer C which does not contain BTCHU. Specifically, on the Kalix® 9950/Kalix® 9950 Primer C shows no shear strength, while Primer B shows about 30% more shear strength compared to Primer A with each method of curing. On the Kalix® 9950/SUS 304, Primer C shows a very low shear strength, while Primer B shows about a 24% improvement in shear strength as compared to Primer A with each method of curing. These improvements demonstrate the enhanced shear strength realized by the composition of the present invention, in particular when used with a polyamide substrate.

The composition of the present invention also shows improvements in shear strength when used on substrates other than polyamide substrates. In particular, as shown in the figures, Primer C shows no shear strength on Nylon 6,6/Nylon 6,6 and Nylon 6,6/SUS 304 and Primer B shows about a 50% increase in shear strength as compared with Primer A.

TABLE 3

| | Room Temperature, 24 hour cure (MPa) | | |
|---|---|---|---|
| Substrate | Primer A | Primer B | Primer C |
| Kalix ® 9950/Kalix ® | 8.1 +/− 0.2 | 12.4 +/− 0.8 | 0.0 +/− 0.0 |
| 9950 | | | |
| Kalix ® 9950/SUS 304 | 10.0 +/− 0.8 | 13.6 +/− 0.6 | 0.3 +/− 0.2 |
| Nylon 6,6/Nylon 6,6 | 2.4 +/− 0.2 | 6.0 +/− 0.2 | 0.0 +/− 0.2 |
| Nylon 6,6/SUS 304 | 4.5 +/− 0.5 | 7.8 +/− 0.5 | 0.3 +/− 0.2 |
| SUS 304/SUS 304 | 14.0 +/− 1.4 | 14.2 +/− 1.1 | 0.5 +/− 0.4 |

TABLE 4

| | 20 minutes at 65° C./Room Temperature | | |
|---|---|---|---|
| | 24 hour cure (MPa) | | |
| Substrate | Primer A | Primer B | Primer C |
| Kalix ® 9950/Kalix ® | 9.4 +/− 0.8 | 12.5 +/− 1.1 | 0.0 +/− 0.0 |
| 9950 | | | |
| Kalix ® 9950/SUS 304 | 11.2 +/− 0.6 | 12.8 +/− 0.6 | 0.3 +/− 0.2 |
| Nylon 6,6/Nylon 6,6 | 3.2 +/− 0.5 | 5.6 +/− 0.5 | 0.0 +/− 0.2 |
| Nylon 6,6/SUS 304 | 4.5 +/− 0.2 | 7.5 +/− 0.3 | 0.3 +/− 0.2 |
| SUS 304/SUS 304 | 14.5 +/− 1.7 | 16.5 +/− 1.4 | 0.5 +/− 0.4 |

What is claimed is:

1. A process for preparing a reaction product from a curable composition, comprising the steps of:
applying a composition comprising an organohalide and a benzoylthiourea or benzoylthiourethane derivative within structures I or IA 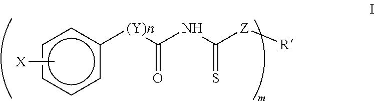
wherein R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2, or 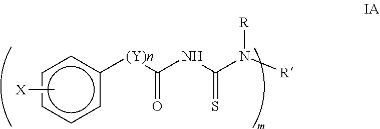
wherein R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2, to a surface of a polyamide substrate,
applying a composition comprising a (meth)acrylate component and an oxidant to the primer-applied polyamide surface or to a surface of a second substrate,
mating the two surfaces to form an assembly, and
exposing the assembly to appropriate conditions for a time sufficient to cure the composition.

2. A process for preparing a reaction product from a curable composition, comprising the steps of:
applying a composition comprising a (meth)acrylate component and an oxidant to a surface of a substrate,
applying a composition comprising an organohalide and a benzoylthiourea or benzoylthiourethane derivative within structures I or IA 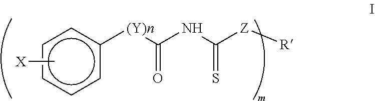
wherein R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2, or 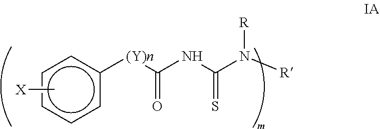
wherein R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2, to the surface of a polyamide substrate
mating the surfaces to form an assembly, and
exposing the assembly to appropriate conditions for a time sufficient to cure the composition.

3. A process for preparing a reaction product from a curable composition, comprising the steps of:
applying a composition comprising a (meth)acrylate component and a benzoylthiourea or benzoylthiourethane derivative within structures I or IA 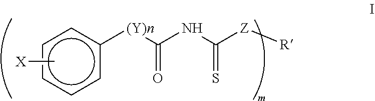
wherein R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2, or 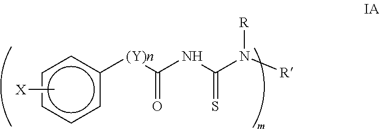
wherein R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2, to a surface of a polyamide substrate,
applying an oxidant to that surface,
mating a second surface to that surface to form an assembly, and
exposing the assembly to appropriate conditions for a time sufficient to cure the composition.

4. A primer composition comprising:
a benzoylthiourea or benzoylthiourethane derivative within structures I or IA 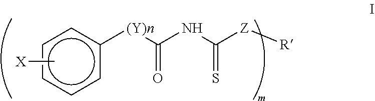
wherein R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2, or 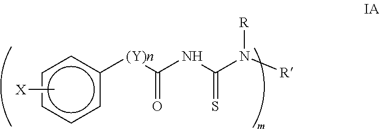
wherein R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2,
in an organohalide carrier.
